(19) United States
(12) Patent Application Publication
(10) Pub. No.: US 2024/0401215 A1
(43) Pub. Date: Dec. 5, 2024

(54) METHOD FOR PRODUCING ELECTRODE CATALYST AND ELECTRODE CATALYST

(71) Applicant: HONDA MOTOR CO., LTD., TOKYO (JP)

(72) Inventors: Osamu USAKA, WAKO-SHI (JP); Hiroshi MATSUMORI, WAKO-SHI (JP); Hiroaki KOMODA, WAKO-SHI (JP)

(21) Appl. No.: 18/671,267

(22) Filed: May 22, 2024

(30) Foreign Application Priority Data
May 29, 2023 (CN) 202310618266.1

(51) Int. Cl. C25B 11/081; C25B 11/065; H01M 4/90; H01M 4/92

(52) U.S. Cl. CPC C25B 11/081; C25B 11/065; H01M 4/9083; H01M 4/926

(57) ABSTRACT

A method for producing an electrode catalyst includes a nanowire synthesis process of synthesizing metal nanowires, and a supporting process of supporting the metal nanowires on a carbon support. The supporting process is performed in a manner so that, in a first suspension containing the carbon support and the metal nanowires, while the metal nanowires are cut into short metal nanowires each having a length equal to or less than the particle diameter of the carbon support, the short metal nanowires are attached to the carbon support.

### CROSS-REFERENCE TO RELATED APPLICATIONS

This application is based upon and claims the benefit of priority from Chinese Patent Application No. 202310618266.1 filed on May 29, 2023, the contents of which are incorporated herein by reference.

### BACKGROUND OF THE INVENTION

### Field of the Invention

The present invention relates to a method for producing an electrode catalyst suitable for an electrode of an electrochemical cell, and to an electrode catalyst.

### Description of the Related Art

In an electrode of an electrochemical cell such as a fuel cell, a water electrolysis device, and various sensors, an oxygen reduction reaction is known as a relatively low rate reaction. In order to rapidly perform such an oxygen reduction reaction, a catalyst in which an active metal such as a noble metal is supported on a support (for example, carbon) is used.

For example, JP 2005-216661 A discloses a catalyst for a fuel cell in which platinum is supported on a carbon support. Further, Li et al. (Science, 2016, vol. 354, Issue. 6318, pp. 1414 to 1419) reports a method for synthesizing platinum nanowires in which platinum is formed into wires having a diameter of several nanometers.

### SUMMARY OF THE INVENTION

However, it has been found that, when the amount of the synthesized platinum nanowires is increased and the platinum nanowires are supported on the carbon support to form a catalyst, sufficient catalytic activity cannot be obtained.

The present invention has the object of solving the aforementioned problem.

According to one aspect of the following disclosure, there is provided a method for producing an electrode catalyst, the method comprising: synthesizing metal nanowires; and supporting the metal nanowires on a carbon support, wherein the supporting of the metal nanowires on the carbon support is performed in a manner so that, in a first suspension containing the carbon support and the metal nanowires, while the metal nanowires are cut into short metal nanowires each having a length equal to or less than a particle diameter of the carbon support, the short metal nanowires are attached to the carbon support.

According to another aspect, there is provided an electrode catalyst, comprising: metal nanowires; and a carbon support on which the metal nanowires are supported, wherein an average length of the metal nanowires is equal to or less than an average particle diameter of the carbon support.

According to the method for producing the electrode catalyst and the electrode catalyst of the above aspects, high catalytic activity can be realized.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an electron micrograph of an electrode catalyst according to an embodiment (Example 1);

FIG. 2 is an explanatory view of a nanowire synthesis process of a method for producing an electrode catalyst according to the embodiment;

FIG. 3 is an explanatory view of a supporting process of the method for producing the electrode catalyst according to the embodiment;

FIG. 4 is a view showing the measurement result of the length distribution of metal nanowires of the electrode catalyst of Example 1; and

FIG. 5 is a graph showing the results of evaluation of the mass activity ratio by the RDE method for the electrode catalyst of Example 1 and the electrode catalyst of Comparative Example 1.

### DETAILED DESCRIPTION OF THE INVENTION

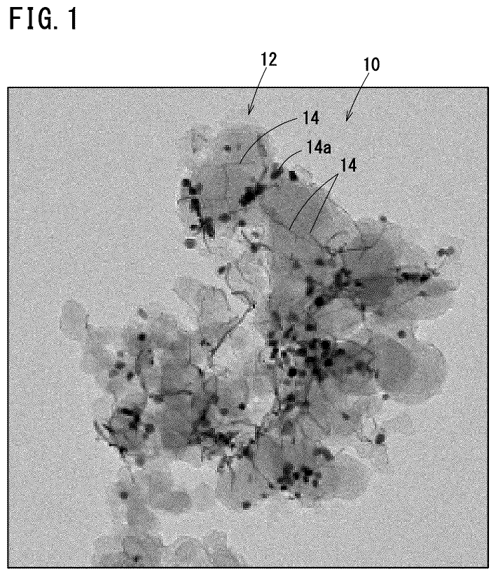

As shown in FIG. 1, an electrode catalyst 10 of the present embodiment has a structure in which metal nanowires 14 that have been shortened are dispersed and supported on the surface of a carbon support 12. Such an electrode catalyst 10 is suitably used for an electrode of an electrochemical cell such as a fuel cell or a water electrolysis device.

The carbon support 12 is not particularly limited as long as it is made of a carbon material capable of supporting the metal nanowires 14. As the carbon support 12, for example, the following carbon materials can be used: CA250 (trade name, manufactured by Denka Company Limited), OSAB (trade name, manufactured by Denka Company Limited), VULCAN (trade name, manufactured by Cabot Corporation), KETJEN BLACK (trade name, manufactured by Ketjen Black International Company), NORIT (trade name, manufactured by Norit), BLACK PEARLS (trade name, manufactured by Cabot Corporation), Acetylene Black (trade name, manufactured by Chevron Corporation), and VGCF (trade name, manufactured by Resonac Holdings Corporation). Further, the carbon support 12 may be formed of carbon nanotubes, carbon nanohorns, carbon nanowalls, carbon nanofibers, or the like.

The carbon support 12 is dispersed as particles in a solution used in a supporting process. In the present specification, the particle diameter of the carbon support 12 is a particle diameter measured in the solution of the carbon support 12. In the solution, a plurality of the carbon supports 12 may aggregate to form one particle, and the particle diameter of the carbon support 12 in the present specification may include the particle diameter of the carbon support 12 as an aggregate.

The constituent elements of the metal nanowires 14 may be appropriately selected from arbitrary metal elements depending on the purpose. The metal nanowires 14 may be made of a base metal element such as nickel (Ni), copper (Cu), iron (Fe), cobalt (Co), tin (Sn), aluminum (Al), zinc (Zn), titanium (Ti), niobium (Nb), tungsten (W), molybdenum (Mo), chromium (Cr), or vanadium (V). Further, the metal nanowires 14 may be made of a noble metal element such as platinum (Pt), silver (Ag), gold (Au), palladium (Pd), rhodium (Rh), iridium (Ir), ruthenium (Ru), or osmium (Os). The above-mentioned element alone, or a compound with other element(s) may be contained in the metal nanowires 14, or two or more of the above-mentioned elements may be contained or used in combination in the metal nanowires 14. Further, the metal nanowires 14 may be made of an alloy in which some of the above-mentioned elements are combined.

In general, the metal nanowires 14 each have a diameter of approximately 1 nm to 10 nm, and have a structure in which metal atoms are connected in a wire shape. The lengths of the metal nanowires 14 vary depending on the type of material or the manufacturing method, but are generally about several 100 nm to several μm. The metal nanowires 14 each have a long and thin wire shape because the total length thereof is longer than the diameter thereof. The metal nanowires 14 may be in a state of being shortened to have a length shorter than that after synthesis, for example. The metal nanowires 14 are preferably shortened to a length that allows the metal nanowires 14 to be supported on the surface of the carbon support 12. When the synthesized metal nanowires 14 are short, the metal nanowires 14 do not need to be shortened. The average length of the metal nanowires 14 in the electrode catalyst 10 is preferably equal to or less than the particle diameter of the carbon support 12 (or the aggregate thereof).

The metal nanowires 14 may include metal particles 14a generated in the synthesis process. The metal particles 14a are located at the end portions of the metal nanowires 14. The metal particles 14a are formed by the metal being precipitated in clumps at the end portions of the metal nanowires 14.

The electrode catalyst 10 of the present embodiment described above is produced by the following method for producing the electrode catalyst.

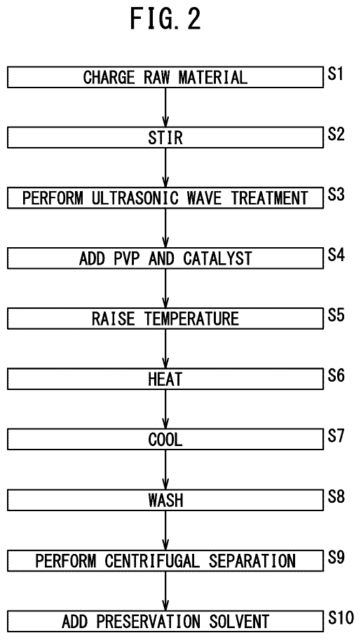

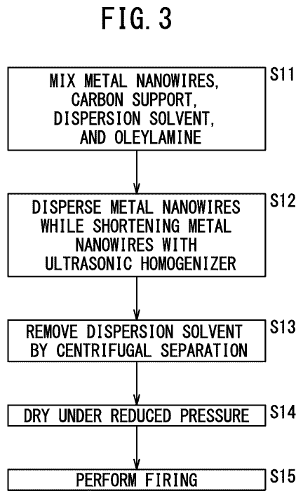

The method for producing the electrode catalyst includes a nanowire synthesis process shown in FIG. 2, and a supporting process shown in FIG. 3. The supporting process is performed after the nanowire synthesis process. As shown in FIG. 2, in the nanowire synthesis process (reaction process), a raw material charging process (step S1) of charging a precursor of the metal nanowires 14, glucose, octadecene (solvent), and oleylamine is first performed.

As the precursor of the metal nanowires 14, a salt of the above-mentioned metal element (metal salt) is used. As the precursor, a substance that is reduced to a metal in a reaction with a mixed solution in the nanowire synthesis process is used.

In the nanowire synthesis process, oleylamine functions as a reducing agent and a stabilizing agent. That is, oleylamine serves as an electron donor at high temperature to reduce platinum or nickel of the precursor. Further, oleylamine covers the surfaces of the produced metal particles 14a to suppress the growth of the metal particles 14a, thereby stopping the particle growth at the nano-size scale. Glucose functions as a reducing agent for the precursor. Instead of glucose, polyols can be used. Examples of the polyol include hexadecanediol, tetraethylene glycol, propylene glycol, trimethylene glycol, diethylene glycol, ethylene glycol, and stearyl glycol.

Next, a process (step S2) of stirring the mixed solution with a stirrer or the like is performed. Thereafter, a treatment (step S3) of further uniformly dispersing the mixed solution by ultrasonic waves is performed. Next, a process (step S4) of adding a protecting agent and a catalyst to the mixed solution is performed. The protecting agent is, for example, polyvinylpyrrolidone (PVP). Polyvinylpyrrolidone has a plurality of CO bonding groups in the molecule. The CO bonding groups of polyvinylpyrrolidone are adsorbed to the precipitated metal, and thus the polyvinylpyrrolidone molecules extending in a chain form surround the metal. This prevents the metal from growing in a lump shape, and the metal grows in a wire shape. The catalyst is added to promote the growth of the metal wire. The catalyst may be, for example, a tungsten (W) complex, a chromium (Cr) complex, or a molybdenum (Mo) complex.

Next, a process (step S5) of gradually raising the temperature of the mixed solution to which the protecting agent and the catalysts have been added, to a predetermined temperature is performed. This process is performed until the temperature of the mixed solution reaches the predetermined temperature (for example, 120° C.).

Thereafter, a process (step S6) of growing (heating) the metal nanowires 14 by maintaining the predetermined temperature (for example, 120° C.) for a predetermined time is performed. The reaction temperature can be set to, for example, 110° C. to 140° C. When the reaction temperature is low, the reaction time needs to be long, and the yield tends to be reduced.

The reaction time of step S6 is preferably one hour or more from the viewpoint of increasing the yield. The reaction time may be, for example, eight hours or more. As the reaction time increases, the length of the synthesized metal nanowires 14 increases.

Next, a cooling process (step S7) of gradually cooling the mixed solution is performed. When the mixed solution is returned to room temperature, the cooling process is ended. The processes of step S5 to step S7 may be performed while stirring (fluidizing) the mixed solution. Appropriate stirring of the mixed solution results in an increased yield of the metal nanowires 14.

Next, a washing process (step S8) of the metal nanowires 14 is performed. In the washing process, the metal nanowires 14 are extracted by a method such as filtration and the metal nanowires 14 are then washed with a solvent containing, for example, acetone, cyclohexane, and ethanol. The washing process may be repeated a plurality of times.

Next, a process (step S9) of recovering the metal nanowires 14 by centrifugal separation is performed. By performing this process, residues such as the precursor and the catalyst are further removed from the metal nanowires 14.

The metal nanowires 14 obtained by the above processes can be synthesized in a state where the periphery thereof is surrounded by polyvinylpyrrolidone. Hydrophobic bonding of polyvinylpyrrolidone surrounding the plurality of metal nanowires 14 occurs due to interaction of the nonpolar groups. Therefore, the metal nanowires 14 are dispersed in the solvent in a state where the plurality of metal nanowires 14 are aggregated in a bundle form via polyvinylpyrrolidone. When such metal nanowires 14 are dried, the condensation of the metal nanowires 14 further progresses, and therefore, the dispersibility of the metal nanowires 14 is deteriorated, and the dispersion of the metal nanowires 14 on the carbon support 12 becomes difficult.

Therefore, a preservation process (step S10) of adding a preservation solvent to the metal nanowires 14 is performed. In this preservation process, the preservation solvent is added to the metal nanowires 14 to prevent the metal nanowires 14 from drying. The preservation solvent is, for example, ethanol. Further, a treatment of uniformly dispersing the metal nanowires 14 in the preservation solvent by applying ultrasonic waves to the preservation solvent and the metal nanowires 14 is performed.

Thereafter, the metal nanowires 14 are subjected to the supporting process (FIG. 3) in a state of being dispersed in the preservation solvent.

As shown in FIG. 3, in the supporting process, first, a suspension preparation process (step S11) of preparing a first suspension (metal nanowire dispersion) in which the carbon support 12, a dispersion solvent, and the metal nanowires 14 are mixed is performed. The metal nanowires 14 are put into the dispersion solvent together with the preservation solvent. In one example, the metal nanowires 14 are put into the dispersion solvent in an amount of 30% by weight of the catalyst. The amount of the metal nanowires 14 is not limited to this example, and the metal nanowires 14 may be put into the dispersion solvent in an amount of 50% by weight of the catalyst.

The dispersion solvent is, for example, a solvent containing ethanol and cyclohexane. Although not particularly limited, the dispersion solvent may contain a dispersant for improving the dispersibility of the metal nanowires 14. As the dispersant, for example, a surfactant such as a cationic surfactant can be used. Oleylamine as the dispersant is suitable because it allows the metal nanowires 14 aggregated in a bundle form by polyvinylpyrrolidone to be efficiently dispersed.

Next, a shortening process (step S12) of treating the first suspension with an ultrasonic homogenizer is performed. In the shortening process, ultrasonic waves are applied to the first suspension by the ultrasonic homogenizer. As a result, the bundled metal nanowires 14 are separated, and the separated metal nanowires 14 are shortened. The length of the metal nanowires 14 has a value corresponding to the frequency and the output of the ultrasonic homogenizer. The metal nanowires 14 that have been shortened are attached to the surface of the carbon support 12 in a dispersed state, and thus the electrode catalyst 10 is produced.

When the treatment is not performed using the ultrasonic homogenizer, the dispersion of the metal nanowires 14 formed in a bundle form does not proceed, the metal nanowires 14 cannot be supported on the carbon support 12, and sufficient catalytic activity cannot be obtained.

Next, a centrifugal separation process (step S13) is performed in order to take out the electrode catalyst 10 from the first suspension. The first suspension is separated into a precipitate layer containing the electrode catalyst 10 and a supernatant layer by the centrifugal separation treatment. The supernatant layer (dispersion solvent) is removed, and the precipitate layer is recovered, whereby a concentrated suspension of the electrode catalyst 10 is obtained.

Next, a drying process (step S14) of drying the concentrated suspension of the electrode catalyst 10 under reduced pressure is performed. The solvent is removed from the electrode catalyst 10 in the drying process.

Thereafter, a firing process (step S15) is performed in order to remove organic substances attached to the electrode catalyst 10. The firing process is performed in a reducing atmosphere of an inert gas containing, for example, about 3% hydrogen gas. The firing process includes a heat treatment at a temperature of 200° C. to 500° C., and more preferably 250° C. or higher.

The electrode catalyst 10 of the present embodiment is produced by the processes described above.

### Example 1

In this example, the metal nanowires 14 made of only platinum were synthesized and supported on the carbon support 12. The composition of the mixed solution prepared in the nanowire synthesis process was as follows: 18.17 mmol of platinum (II) acetylacetonate (Pt(acac)₂), 22.5 mmol of glucose, 0.225 mmol of polyvinylpyrrolidone (PVP), 0.15 mmol of hexacarbonyltungsten (W(CO)₆), 30 ml of 1-octadecene, and 45 ml of oleylamine.

The mixed solution having the above-described preparation composition was subjected to the process (step S6 in FIG. 2) in which the mixed solution was reacted at 120° C. for 3 hours while being stirred. By this process, the metal nanowires 14 according to Example 1 were produced. Thereafter, the metal nanowires 14 of Example 1 were subjected to the supporting process.

The composition of the first suspension prepared in the supporting process was as follows: 9630 mg of the carbon support 12 (Vulcan XC series), 107 mg of the metal nanowires 14, 200 ml of ethanol, 200 ml of cyclohexane, and 20 ml of oleylamine. The first suspension was treated with the ultrasonic homogenizer for 60 minutes. By the above treatment, the electrode catalyst 10 of the present example was obtained.

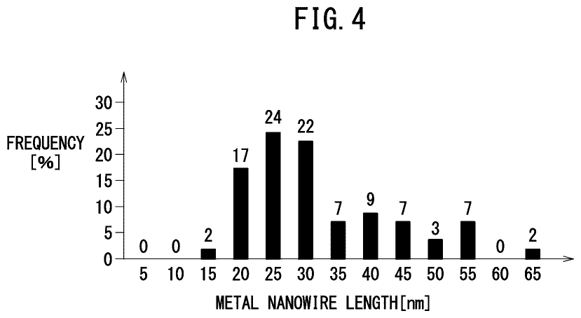

The electrode catalyst 10 of the present example was evaluated using a transmission electron microscope. As a result of the evaluation, the length distribution of the metal nanowires 14 as shown in FIG. 4 was obtained. The average length of the metal nanowires 14 of Example 1 was 29.4 nm. The average length of the metal nanowires 14 was equal to or less than the particle diameter (average value) of the carbon support 12.

### Comparative Example 1

Comparative Example 1 is an electrode catalyst obtained by bringing the metal nanowires 14 produced by the same method as in Example 1 into contact with the carbon support 12 without shortening the metal nanowires 14 with the ultrasonic homogenizer.

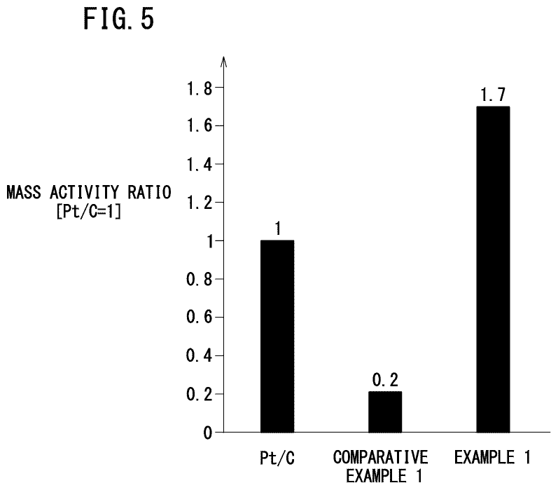

Next, the electrode catalyst 10 of Example 1 and the electrode catalyst of Comparative Example 1 were measured for catalytic activity by the RDE method. The results are shown in FIG. 5. FIG. 5 shows the relative values of the mass activity ratio when the mass activity ratio of a conventional catalyst in which platinum fine particles are supported on the carbon support 12 (hereinafter referred to as catalyst (Pt/C)) is 1. In a case where this value is larger than 1, it indicates that the catalytic activity per mass of platinum is higher than that of the catalyst (Pt/C).

As shown in FIG. 5, in the electrode catalyst of Comparative Example 1, the metal nanowires 14 were not sufficiently dispersed, and the obtained catalytic activity was lower than that of the catalyst (Pt/C). In contrast, the electrode catalyst 10 of Example 1 had a catalytic activity 1.7 times higher than that of the catalyst (Pt/C), and thus it was confirmed that a high catalytic activity was obtained.

The following supplementary notes are further disclosed in relation to the above-described disclosure.

### Supplementary Note 1

One aspect resides in the method for producing the electrode catalyst, the method including: synthesizing the metal nanowires (14); and supporting the metal nanowires on the carbon support (12), wherein the supporting of the metal nanowires on the carbon support is performed in a manner so that, in the first suspension containing the carbon support and the metal nanowires, while the metal nanowires are cut into short metal nanowires each having a length equal to or less than the particle diameter of the carbon support, the short metal nanowires are attached to the carbon support. This method for producing the electrode catalyst can effectively disperse the metal nanowires aggregated in a bundle form, and thus can produce an electrode catalyst having high catalytic activity.

### Supplementary Note 2

In the above method for producing the electrode catalyst, the supporting of the metal nanowires on the carbon support may include: preparing the first suspension by mixing the metal nanowires, the carbon support, and the solvent; and while cutting the metal nanowires into the short metal nanowires by applying ultrasonic waves to the first suspension using the ultrasonic homogenizer, attaching the short metal nanowires to the carbon support. This method for producing the electrode catalyst can effectively shorten the metal nanowires.

### Supplementary Note 3

In the above method for producing the electrode catalyst, the first suspension may contain a surfactant. This method for producing the electrode catalyst can effectively disperse the metal nanowires aggregated in a bundle form.

### Supplementary Note 4

In the method for producing the electrode catalyst, the synthesizing of the metal nanowires may include: reacting the mixed solution containing the precursor of the metal nanowires and the protecting agent to precipitate the metal nanowires in which metal atoms are connected in a wire shape; and dispersing and preserving the metal nanowires that have been precipitated, in the preservation solvent without causing the metal nanowires to dry, and in the supporting of the metal nanowires on the carbon support, the metal nanowires dispersed in the preservation solvent may be used. The above method for producing the electrode catalyst can improve the dispersibility of the metal nanowires in the supporting of the metal nanowires on the carbon support by preventing the synthesized metal nanowires from drying.

### Supplementary Note 5

In the method for producing the electrode catalyst, the synthesizing of the metal nanowires may be performed by reacting the mixed solution at a temperature of 120° C. for one hour or more. This method for producing the electrode catalyst can produce metal nanowires at a high yield.

### Supplementary Note 6

In the method for producing the electrode catalyst, the synthesizing of the metal nanowires may be performed while fluidizing the mixed solution. This method for producing the electrode catalyst can further increase the yield of the metal nanowires.

### Supplementary Note 7

In the method for producing the electrode catalyst, in the synthesizing of the metal nanowires, the precursor may be a metal salt containing at least one element selected from nickel (Ni), copper (Cu), iron (Fe), cobalt (Co), tin (Sn), aluminum (Al), zinc (Zn), titanium (Ti), niobium (Nb), tungsten (W), molybdenum (Mo), chromium (Cr), vanadium (V), platinum (Pt), silver (Ag), gold (Au), palladium (Pd), rhodium (Rh), iridium (Ir), ruthenium (Ru), and osmium (Os). This method for producing the electrode catalyst can produce an electrode catalyst exhibiting high catalytic activity.

### Supplementary Note 8

Another aspect resides in the electrode catalyst including: the metal nanowires; and the carbon support on which the metal nanowires are supported, wherein the average length of the metal nanowires is equal to or less than the average particle diameter of the carbon support. This electrode catalyst exhibits high catalytic activity.

### Supplementary Note 9

In the electrode catalyst, the carbon support to which the metal nanowires are attached may have a structure obtained by, while cutting the metal nanowires into the short metal nanowires by applying, using the ultrasonic homogenizer, ultrasonic waves to the mixed solution in which the metal nanowires, the carbon support, and the solvent are mixed, dispersing the short metal nanowires in the carbon support. This electrode catalyst is excellent in catalytic activity.

### Supplementary Note 10

In the electrode catalyst, the metal nanowires may be synthesized in a liquid phase and then mixed with the carbon support and the solvent without being dried. The electrode catalyst has few metal nanowires aggregated in a bundle form and is excellent in catalytic activity.

The present invention is not limited to the above disclosure, and various modifications are possible without departing from the essence and gist of the present invention.

1. A method for producing an electrode catalyst, the method comprising:
synthesizing metal nanowires; and
supporting the metal nanowires on a carbon support,
wherein the supporting of the metal nanowires on the carbon support is performed in a manner so that, in a first suspension containing the carbon support and the metal nanowires, while the metal nanowires are cut into short metal nanowires each having a length equal to or less than a particle diameter of the carbon support, the short metal nanowires are attached to the carbon support.

2. The method for producing the electrode catalyst according to claim 1, wherein
the supporting of the metal nanowires on the carbon support includes:
preparing the first suspension by mixing the metal nanowires, the carbon support, and a solvent; and
while cutting the metal nanowires into the short metal nanowires by applying ultrasonic waves to the first suspension using an ultrasonic homogenizer, attaching the short metal nanowires to the carbon support.

3. The method for producing the electrode catalyst according to claim 2, wherein
the first suspension contains a surfactant.

4. The method for producing the electrode catalyst according to claim 1, wherein
the synthesizing of the metal nanowires includes:
reacting a mixed solution containing a precursor of the metal nanowires and a protecting agent to precipitate the metal nanowires in which metal atoms are connected in a wire shape; and
dispersing and preserving the metal nanowires that have been precipitated, in a preservation solvent without causing the metal nanowires to dry, and
in the supporting of the metal nanowires on the carbon support, the metal nanowires dispersed in the preservation solvent are used.

5. The method for producing the electrode catalyst according to claim 4, wherein
the synthesizing of the metal nanowires is performed by reacting the mixed solution at a temperature of 120° C. for one hour or more.

6. The method for producing the electrode catalyst according to claim 5, wherein
the synthesizing of the metal nanowires is performed while fluidizing the mixed solution.

7. The method for producing the electrode catalyst according to claim 5, wherein
in the synthesizing of the metal nanowires, the precursor is a metal salt containing at least one element selected from nickel (Ni), copper (Cu), iron (Fe), cobalt (Co), tin (Sn), aluminum (Al), zinc (Zn), titanium (Ti), niobium (Nb), tungsten (W), molybdenum (Mo), chromium (Cr), vanadium (V), platinum (Pt), silver (Ag), gold (Au), palladium (Pd), rhodium (Rh), iridium (Ir), ruthenium (Ru), and osmium (Os).

8. An electrode catalyst, comprising:
metal nanowires; and
a carbon support on which the metal nanowires are supported,
wherein an average length of the metal nanowires is equal to or less than an average particle diameter of the carbon support.

9. The electrode catalyst according to claim 8, wherein
the carbon support to which the metal nanowires are attached has a structure obtained by, while cutting the metal nanowires into short metal nanowires by applying, using an ultrasonic homogenizer, ultrasonic waves to a mixed solution in which the metal nanowires, the carbon support, and a solvent are mixed, dispersing the short metal nanowires in the carbon support.

10. The electrode catalyst according to claim 8, wherein
the metal nanowires are synthesized in a liquid phase and then mixed with the carbon support and a solvent without being dried.
